(19) United States
(12) Patent Application Publication
(10) Pub. No.: US 2018/0341601 A1
(43) Pub. Date: Nov. 29, 2018

(54) INFORMATION PROCESSING APPARATUS, CONTROL METHOD THEREOF, AND CONTROL PROGRAM THEREOF

(71) Applicant: Renesas Electronics Corporation, Tokyo (JP)

(72) Inventor: Eiichi ARAI, Tokyo (JP)

(21) Appl. No.: 15/917,605

(22) Filed: Mar. 10, 2018

(30) Foreign Application Priority Data
May 25, 2017 (JP) 2017-103457

(51) Int. Cl. G06F 13/10; G06F 13/16; G06F 13/40

(52) U.S. Cl. CPC G06F 13/105; G06F 13/4068; G06F 13/1668

(57) ABSTRACT

If software for embedded devices is executed in a virtual environment, a simulation stops when an access to an uninstalled area in a virtual environment occurs. An information processing apparatus includes a virtual environment for executing an embedded program for a predetermined embedded device. The virtual environment includes a virtual bus unit. The virtual bus unit includes an access processing unit that processes bus access in the execution of the embedded program. The virtual bus unit includes an area reserving unit that reserves, when an access destination of the bus access is not defined in the virtual environment, a storage area corresponding to the access destination as a stub area in the virtual bus unit.

### CROSS-REFERENCE TO RELATED APPLICATIONS

This application is based upon and claims the benefit of priority from Japanese patent application No. 2017-103457, filed on May 25, 2017, the disclosure of which is incorporated herein in its entirety by reference.

### BACKGROUND

The present disclosure relates to an information processing apparatus, a control method thereof, and a control program thereof. For example, the present disclosure relates to an information processing apparatus including a virtual environment, a control method thereof, and a control program thereof.

Japanese Unexamined Patent Application Publication No. 2011-145880 discloses a technique related to a method of generating a test task to be used in logic verification of a semiconductor integrated circuit. Japanese Unexamined Patent Application Publication No. 2011-145880 discloses that an SoC (System On a Chip) software model is used as a stub in developing firmware for an embedded CPU of an SoC device.

### SUMMARY

Incidentally, there is a problem that if software for embedded devices is executed in a virtual environment, a simulation stops when an access to an uninstalled area in a virtual environment occurs.

Other problems of the related art and new features of the present disclosure will become apparent from the following descriptions of the specification and attached drawings.

According to an example aspect, an information processing apparatus reserves, when an access destination of bus access is not defined in a virtual environment, a storage area corresponding to the access destination as a stub area in a virtual bus unit included in the virtual environment.

According to the above example aspect, it is possible to return an appropriate simulation result when access to an uninstalled area in the virtual environment occurs.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram for describing a hardware configuration of an information processing apparatus according to a first embodiment;

FIG. 2 is a block diagram for describing a software configuration according to the first embodiment;

FIG. 3 is a block diagram for describing a functional configuration of a virtual environment according to the first embodiment;

FIG. 4 is a diagram showing an example of a bus map according to the first embodiment;

FIG. 5 is a flowchart for describing a flow of access destination list registration processing according to the first embodiment;

FIG. 6 is a flowchart for describing a flow of bus access processing according to the first embodiment;

FIG. 7 is a diagram showing an example of a transaction (addressed to a stub area) according to the first embodiment;

FIG. 8 is a diagram showing an example of a transaction (addressed to DMA_1) according to the first embodiment;

FIG. 9 is a diagram showing an example of a transaction (error case) according to the first embodiment;

FIG. 10 is a diagram showing an example of an error message according to the first embodiment;

FIG. 11 is a block diagram for describing an overall configuration of an information processing apparatus according to a second embodiment;

FIG. 12 is a diagram showing an example of entire address space information according to the second embodiment; and

FIG. 13 is a flowchart for describing a flow of bus access processing according to the second embodiment.

### DETAILED DESCRIPTION

For the clarification of the description, the following description and the drawings may be omitted or simplified as appropriate. Further, each element shown in the drawings as functional blocks that perform various processing can be formed of a CPU (Central Processing Unit), a memory, and other circuits in hardware and may be implemented by programs loaded into the memory in software. Those skilled in the art will therefore understand that these functional blocks may be implemented in various ways by only hardware, only software, or the combination thereof without any limitation. Throughout the drawings, the same components are denoted by the same reference signs and overlapping descriptions will be omitted as appropriate.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

### First Embodiment

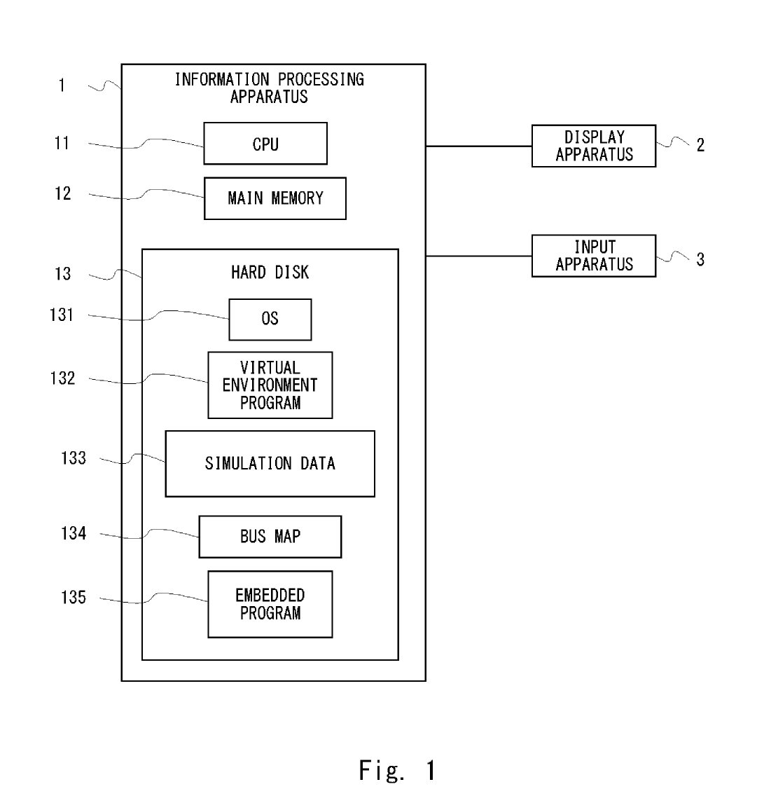

FIG. 1 is a block diagram for describing a hardware configuration of an information processing apparatus 1 according to a first embodiment. The information processing apparatus 1 is an example of a computer system that implements a virtual environment of a microcomputer (not shown). The information processing apparatus 1 is connected to a display apparatus 2 and an input apparatus 3. The display apparatus 2 displays a screen in accordance with an instruction from the information processing apparatus 1. The input apparatus 3 inputs the instruction of a user for the information processing apparatus 1. The input apparatus 3 is, for example, a keyboard for accepting an input of character information from the user, a mouse for designating an arbitrary position on the screen of the display apparatus 2 and accepting an input of an instruction corresponding to an icon or the like displayed at the designated position. However, the apparatuses connected to the information processing apparatus 1 are not limited to them.

The information processing apparatus 1 includes a CPU 11, a main memory 12, and a hard disk 13. The CPU 11 is a control apparatus that reads and executes a predetermined program. The main memory 12 is, for example, a volatile storage apparatus such as a RAM (Random Access Memory). The hard disk 13 is a non-volatile storage apparatus. The hard disk 13 stores an OS (Operating System) 131, a virtual environment program 132, simulation data 133, a bus map 134, an embedded program 135, and the like.

The OS 131 is basic software for operating the information processing apparatus 1. The virtual environment program 132 is software for implementing a microcomputer, which is an embedded device, by software and simulating execution of the embedded program 135 on the microcomputer. The simulation data 133 is various kinds of data used in the simulation. The bus map 134 is management information in which address information of a plurality of virtual peripheral IPs (circuit blocks) etc. defined in the virtual environment implemented by the virtual environment program 132 is defined as access destinations. The embedded program 135 is originally software developed to be executed on a predetermined embedded device. The embedded program 135 is a program to be simulated, which is executed by the virtual environment program 132 for the purpose of debugging and the like.

Here, the CPU 11 loads, into the main memory 12, the OS 131, the virtual environment program 132, the simulation data 133, the bus map 134, and the embedded program 135 that are stored in the hard disk 13. Then, the CPU 11 executes the OS 131 and the virtual environment program 132 loaded into the main memory 12. Moreover, the CPU 11 executes the embedded program 135 by executing the virtual environment program 132. Therefore, it can be said that the information processing apparatus 1 has a virtual environment for executing the embedded program 135 for a predetermined embedded device.

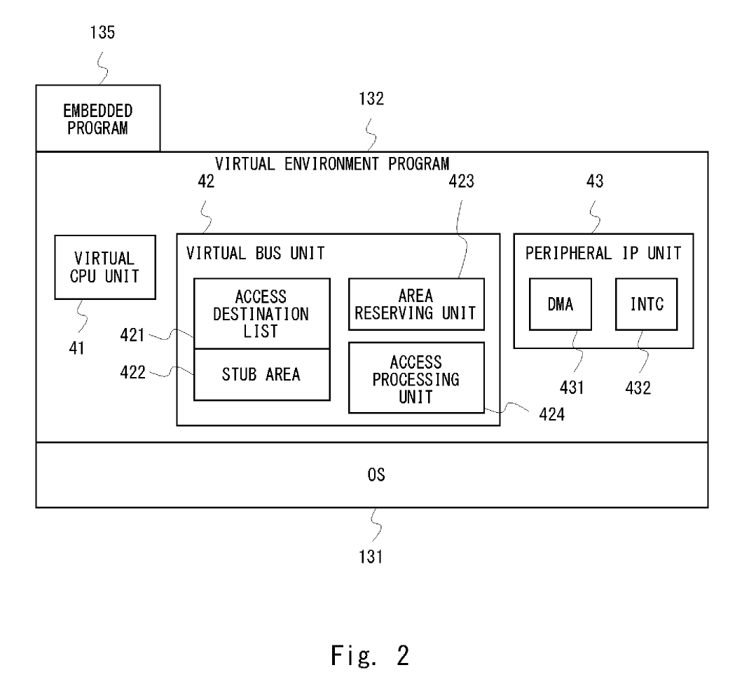

FIG. 2 is a block diagram for describing a software configuration according to the first embodiment. In FIG. 2, it is shown that the virtual environment program 132 operates on the OS 131, and the embedded program 135 operates on the virtual environment program 132. The virtual environment program 132 includes a virtual CPU unit 41, a virtual bus unit 42, and a virtual peripheral IP unit 43. The virtual CPU unit 41, the virtual bus unit 42, and the peripheral IP unit 43 are defined as, for example, classes and implemented by instantiating each of them when the virtual environment program 132 is executed.

The virtual bus unit 42 includes an access destination list 421, a stub area 422, an area reserving unit 423, and an access processing unit 424. The access destination list 421 is information for managing, among the access destinations defined in the bus map 134, address information of slaves connected to the virtual bus unit 42 and address information of the access destinations that pass through the virtual bus unit 42 and that are the address information of the stub area 422 inside the virtual bus unit 42. The stub area 422 is an uninstalled storage area in the virtual environment program 132.

When the access destination of the bus access for the execution of the embedded program 135 is not defined in the virtual environment, the area reserving unit 423 reserves, as the stub area 422, a storage area corresponding to the access destination in the virtual bus unit 42. Note that the access destination list 421 and the stub area 422 are member variables in the virtual bus unit 42, and in practice, areas for the access destination list 421 and the stub area 422 are reserved in the main memory 12. The access processing unit 424 processes bus access. Note that the area reserving unit 423 and the access processing unit 424 are methods, functions, or the like in the virtual bus unit 42.

The peripheral IP unit 43 includes, for example, a DMA (Direct Memory Access) 431 and an INTC (Interrupt Controller) 432. Note that the DMA 431 and the INTC 432 are originally configured as hardware DMA and INTC, respectively, but in this example, they are implemented as software. Note that the peripheral IP unit 43 is not limited to this.

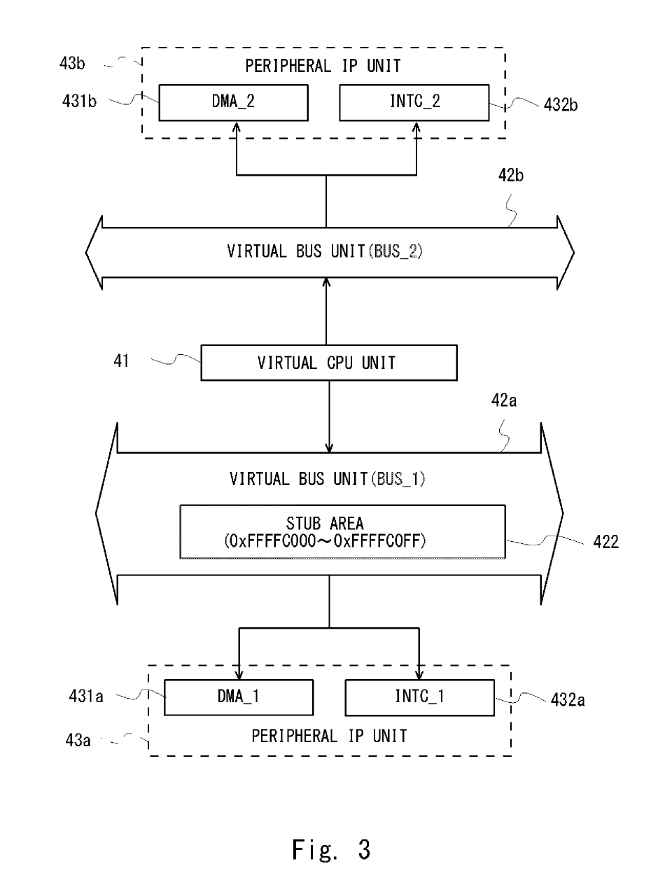

FIG. 3 is a block diagram for describing the functional configuration of the virtual environment according to the first embodiment. The virtual CPU unit 41 is socket-connected to a virtual bus unit 42a and a virtual bus unit 42b. The virtual bus unit 42a is socket-connected to the virtual CPU unit 41 and DMA_1_431a and INTC_1_432a included in the peripheral IP unit 43a. Likewise, the virtual bus unit 42b is socket-connected to the virtual CPU unit 41 and DMA_2_431b and INTC_2_432b included in the peripheral IP unit 43b.

When the simulation of the embedded program 135 is started, the virtual CPU unit 41, the virtual bus units 42a and 42b, the DMA_1_431a and the DMA_2_431b, and the INTC_1 432a and the INTC_2_432b are socket-connected as necessary. Further, when the simulation is started, the virtual bus units 42a and 42b read the bus map 134 and store, in the access destination list 421, the peripheral IPs (slaves) and address ranges of the slaves connected to the virtual bus units 42a and 42b. Further, for example, when stub information of the virtual bus unit 42a is defined in the bus map 134, the virtual bus unit 42a reserves the stub area 422.

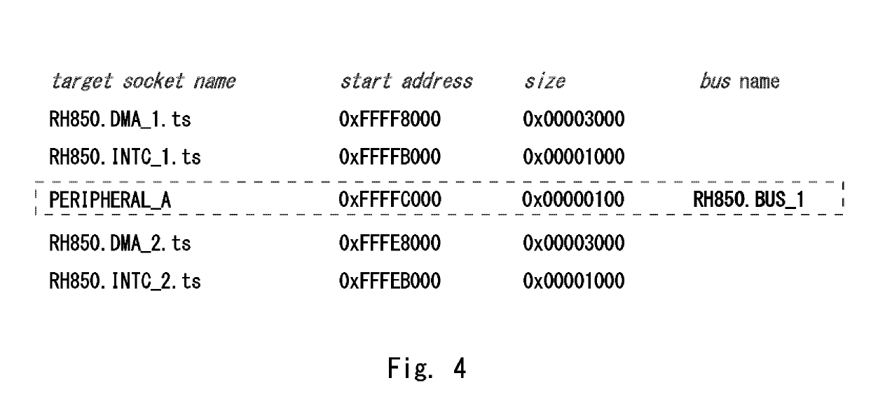

FIG. 4 is a diagram showing an example of the bus map 134 according to the first embodiment. The bus map 134 includes a socket name, a start address, an address size, and a bus name of the peripheral IP unit of the access destination. In particular, in FIG. 4, an example of the stub information is defined in the third item. It is assumed that “PERIPHERAL_A”, which is the access destination, is installed in the target embedded device of the embedded program 135 but not installed in the virtual environment program 132. Further, “RH850.BUS_1” corresponding to the virtual bus unit 42a is defined as the bus name.

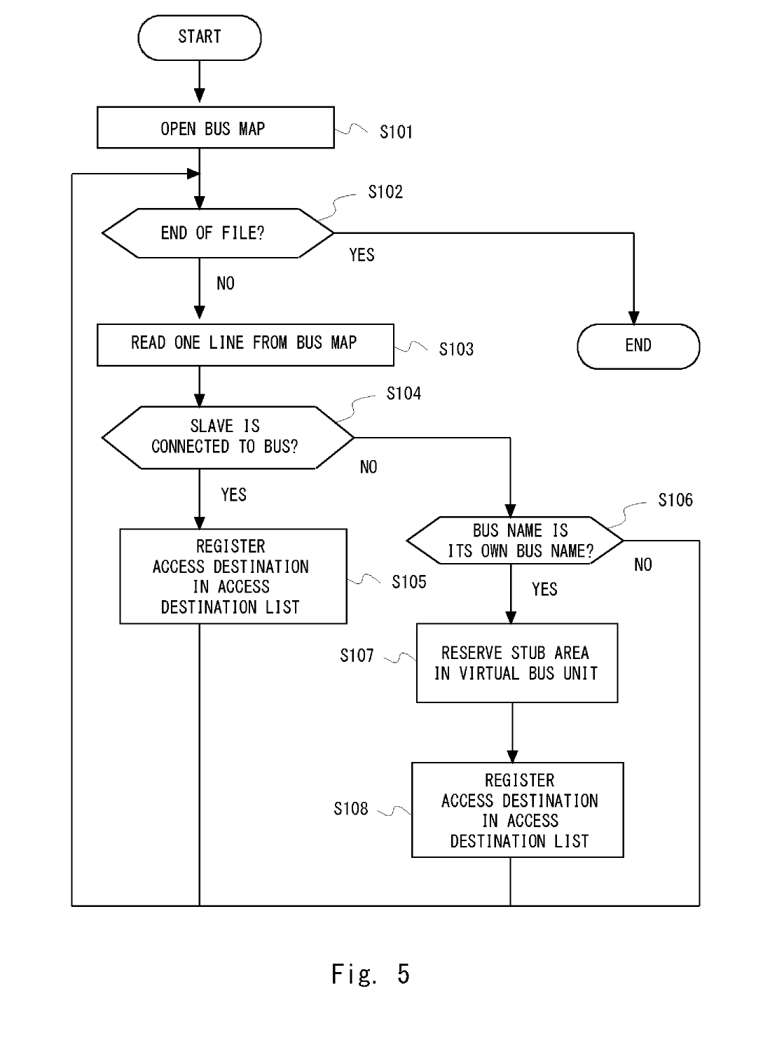

FIG. 5 is a flowchart for describing a flow of the access destination list registration processing according to the first embodiment. The access destination list registration processing is processing when the simulation of the embedded program 135 is started by the virtual environment program 132. Further, it is assumed that the virtual bus unit 42 includes a list of slaves connected to the virtual bus unit 42.

First, the area reserving unit 423 of the virtual bus unit 42 opens the bus map 134 stored in the hard disk 13 (S101). Then, the area reserving unit 423 evaluates as to whether or not a line to be read is the end of a file (S102). For example, in the case of the bus map 134 shown in FIG. 4, immediately after the file is opened, the line to be read is a first line and not the end of the file, and thus the process proceeds to Step S103. On the other hand, when the file is empty or the file has already been read until the end of the file, the access destination list registration processing is ended.

Next, the area reserving unit 423 reads one line of the lines to be read from the bus map 134 (S103). Then, the area reserving unit 423 evaluates as to whether or not the access destination of the read line is the slave (the peripheral IP unit) connected to the virtual bus unit 42 (S104). For example, when the socket name of the access destination indicates the socket name of the DMA_1_431a or INTC_1_432a, the virtual bus unit 42a of FIG. 3 evaluates that it is the slave connected to the virtual bus unit 42a, and the process proceeds to Step S105.

Next, the area reserving unit 423 registers the access destination of the read line in the access destination list 421 (S105). At this time, in addition to a slave name, a start address, and an end address, the area reserving unit 423 may register a socket pointer of the access destination in the access destination list 421. The area reserving unit 423 registers, in the access destination list 421, identification information that enables at least the access destination to be identified as the slave connected to the virtual bus unit 42a.

On the other hand, in Step S104, when the access destination is not the slave connected to the virtual bus unit 42, the area reserving unit 423 evaluates as to whether or not the access destination indicates its own bus name (S106). For example, when the bus name of the bus map 134 is defined as “RH850.BUS_1”, the virtual bus unit 42a in FIG. 3 evaluates that the access destination indicates its own bus name, and the process proceeds to Step S107.

Then, the area reserving unit 423 reserves the stub area 422 in the virtual bus unit 42 (S107). That is, the area reserving unit 423 assigns a storage area corresponding to the size defined in the stub information to an internal variable. For example, the area reserving unit 423 declares an array variable corresponding to the size defined in the stub information. After that, the area reserving unit 423 registers the access destination of the read line in the access destination list 421 (S108). At this time, in addition to the stub name, the start address, the end address, and the pointer to the stub area, the area reserving unit 423 may register the socket pointer of the access destination as “0” in the access destination list 421. The area reserving unit 423 registers, in the access destination list 421, identification information that enables at least the access destination to be identified as the stub information.

After Steps S105 and S108 or when it is determined as NO in Step S106, the process returns to Step S102 to continue the processing.

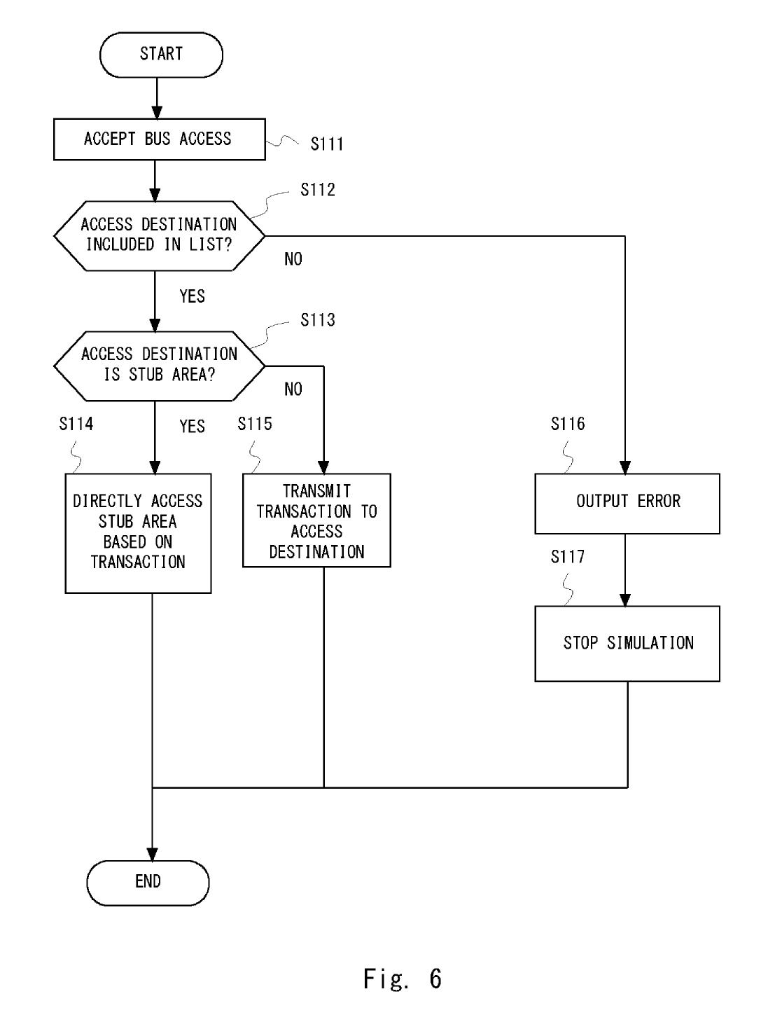

FIG. 6 is a flowchart for describing a flow of the bus access processing according to the first embodiment. First, when bus access to perform reading or writing from or to the register of the peripheral IP occurs while the simulation of the embedded program 135 is being executed, the virtual CPU unit 41 transmits a transaction, which is an access instruction for reading or writing including the address and the size of the access destination, to the virtual bus unit 42. Then, the access processing unit 424 of the virtual bus unit 42 accepts the bus access (S111).

Next, the access processing unit 424 evaluates as to whether or not the access destination of the bus access is included in the access destination list 421 (S112). For example, the access processing unit 424 searches the access destination list 421 for the start address of the bus access transaction. When the search results in a hit, i.e., when the access destination is included in the access destination list 421, the access processing unit 424 evaluates as to whether or not the access destination is the stub area (S113). For example, the access processing unit 424 evaluates as to whether or not the socket pointer associated with the access destination hit in the search is “0”. When the socket pointer is “0”, the access processing unit 424 evaluates that the access destination is the stub area. Alternatively, when the identification information, which enables the access destination to be identified as to whether or not it is the stub information, is registered in the access destination list 421, the access processing unit 424 evaluates as to whether or not the access destination is the stub area based on the identification information.

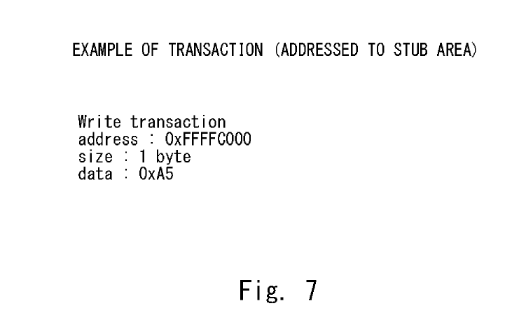

When the access destination is evaluated as the stub area in Step S113, the access processing unit 424 directly accesses the stub area based on the transaction (S114). Here, FIG. 7 is a diagram showing an example of the transaction (addressed to the stub area) according to the first embodiment. In FIG. 7, “address” is “0xFFFFC000”, which indicates that it corresponds to “PERIPHERAL_A” (stub information) in FIG. 4. In this example, the access processing unit 424 issues a Write command of data “0xA5” to 1 byte from the stub area 422 “0xFFFFC000” in the virtual bus unit 42.

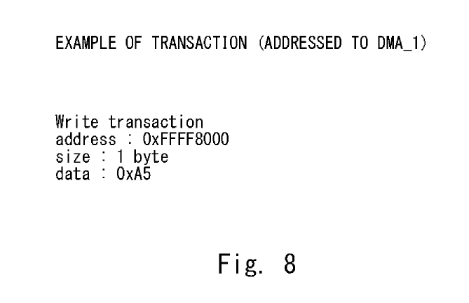

When the access destination is evaluated that it is not the stub area in Step S113, the access processing unit 424 transmits the transaction to the access destination (S115). Here, FIG. 8 is a diagram showing an example of the transaction (addressed to DMA_1) according to the first embodiment. In FIG. 8, “address” is “0xFFFF8000”, which indicates that it corresponds to “RH850.DMA_1.ts” in FIG. 4. In this example, the access processing unit 424 transmits the transaction shown in FIG. 8 to the DMA_1_431a via the socket connection.

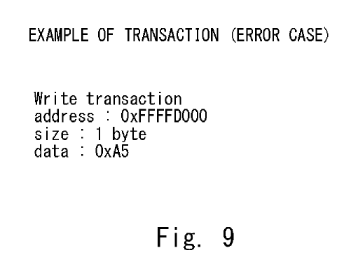

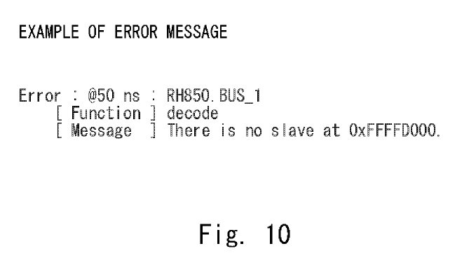

In Step S112, when the access destination is not included in the access destination list 421, the access processing unit 424 outputs an error message to the display apparatus 2 (S116). Then, the access processing unit 424 stops the simulation (S117). For example, FIG. 9 is a diagram showing an example of the transaction (error case) according to the first embodiment. In FIG. 9, “address” is “0xFFFFD000”, which indicates that it is not defined in the bus map 134 of FIG. 4. Therefore, the access destination is not also registered in the access destination list 421. FIG. 10 is a diagram showing an example of the error message according to the first embodiment. Note that “0xFFFFD000” may be present in an embedded device corresponding to the embedded program 135, but may be an uninstalled area which is not defined in the virtual environment program 132. Alternatively, “0xFFFFD000” may be an area not allowed by the embedded device.

Here, in the initial simulation, information about the uninstalled area of the virtual environment is often unknown in advance. Therefore, it may be difficult to previously define the stub information in the bus map 134. For this reason, as an example, the following debugging work may be carried out.

First, during the initial simulation, the bus access processing of this embodiment is executed by using the bus map with the initial setting (i.e., the stub area is not defined in the bus map). Then, when an error is output, the user determines the error message as either (A) or (B) shown below. (A) It is an address which is not allowed by hardware. (B) It is an address allowed by hardware, but in the virtual environment, the access destination is not connected to the virtual bus unit as the peripheral IP.

When the user determines the error message as (A), this is an error in the embedded program. Therefore, the user modifies the embedded program. Whereas when the user determines the error message as (B), the stub area is defined in the bus map, as described above, based on the contents of the error message. This processing is repeated. In this way, by repeating trial and error, it is possible to easily obtain information about the access to the uninstalled area. Therefore, the efficiency of the debugging work can be improved.

Further, the above-described embodiments can also be expressed as follows. Specifically,

an information processing apparatus including a virtual environment for executing an embedded program for a predetermined embedded device.

The virtual environment includes a virtual bus unit including an access processing unit that processes bus access in the execution of the embedded program.

The virtual bus unit includes an area reserving unit that reserves, when an access destination of the bus access is not defined in the virtual environment, a storage area corresponding to the access destination as a stub area in the virtual bus unit.

Thus, it is possible to return an appropriate simulation result when access to an uninstalled area in the virtual environment occurs.

Further, when the access destination is a slave connected to the virtual bus unit, desirably the access processing unit transmits an access instruction regarding the bus access to the access destination.

When the access destination is the stub area, desirably the access processing unit directly accesses the stub area in accordance with the access instruction.

Thus, when write access to the reserved stub area occurs, a write value is held. Therefore, the write value is appropriately read in subsequent read access to the stub area.

Moreover, as the bus access can be made without going through the socket connection with the slave, there is no need to configure a dummy memory in the virtual environment. For this reason, for example, even when access to the uninstalled area of the virtual environment is detected during the debugging work, it is not necessary to rebuild the virtual environment in order to configure the dummy memory. The debugging time can thus be shortened. In some cases, rebuilding may take several hours depending on the scale of the virtual environment and the build environment. In such a case, the effect of this embodiment would be remarkable.

Moreover, the information processing apparatus desirably further includes a storage unit configured to store a bus map that defines address information of a plurality of circuit blocks defined in the virtual environment as the access destinations.

The bus map desirably further defines the address information of the access destination not defined in the virtual environment as stub information.

The area reserving unit desirably refers to the bus map and reserves the storage area corresponding to the stub information as the stub area in the virtual bus unit.

Thus, by describing the stub information in advance in a text file called bus map, it is possible to reserve the stub area without having to rebuild the virtual environment.

Furthermore, the area reserving unit may

read the bus map when the execution of the embedded program is started,

register, among the access destinations defined in the bus map, the address information of the slave connected to the virtual bus unit of the information processing apparatus in an access destination list in the virtual bus unit, and

when the stub information is defined in the bus map, further register the stub information in the access destination list.

When the access processing unit accepts the bus access, the access processing unit may refer to the access destination list and evaluates as to whether or not the access destination is the stub area.

Thus, as the access destination list in the virtual bus unit is referred to during the bus access, the access processing can be speeded up.

Alternatively, when the access processing unit accepts the bus access and the access destination is not defined in the bus map, the access processing unit may output the bus access as an error.

Thus, regarding the output error, the user can evaluate as to whether or not the access is unauthorized access. When the access is access to the uninstalled area, the stub information can be easily added to the bus map. That is, when bus access to a peripheral register not defined in the virtual environment occurs, the simulation is temporarily stopped and the user is prompted to check. In this way, unauthorized access will not be overlooked.

### Second Embodiment

The second embodiment is an improved example of the above-described first embodiment. For example, in the above-described first embodiment, when the simulation is stopped (S117) by the error output (S116), the user refers to a hardware specification of the corresponding embedded device and evaluates the reason for the stop. Then, the stub information needs to be added to the bus map as necessary. On the other hand, in the second embodiment, the virtual environment automatically evaluates as to whether or not the stub area is necessary, and if necessary, it reserves the stub area and allows the access.

That is, the information processing apparatus further includes a storage unit configured to store entire address space information, the entire address space information defining the address information of all of the access destinations in the execution of the embedded program.

When there is, in the entire address space information, the access destination not defined in the virtual environment among the access destinations of the bus access, the area reserving unit reserves the storage area corresponding to the access destination as the stub area in the virtual bus unit.

Thus, even when the access to the uninstalled area cannot be known in advance, the stub area can be automatically added. Therefore, the efficiency of the debugging work can be further improved.

Further, the area reserving unit may register the stub information indicating the reserved stub area in the access destination list.

When the access processing unit accepts the bus access, it may refer to the access destination list and when the access destination is the stub area, the access processing unit directly accesses the stub area in accordance with the access instruction regarding the bus access. This makes it unnecessary to reserve the stub area again, and the efficiency of the processing can be improved.

Moreover, when it is evaluated that the access destination is not included in the entire address space information, the access processing unit may output the bus access as unauthorized access.

Thus, since it is certain that the bus access is unauthorized access, user evaluation will be unnecessary. It is therefore possible to reduce the load on the user in the debugging work.

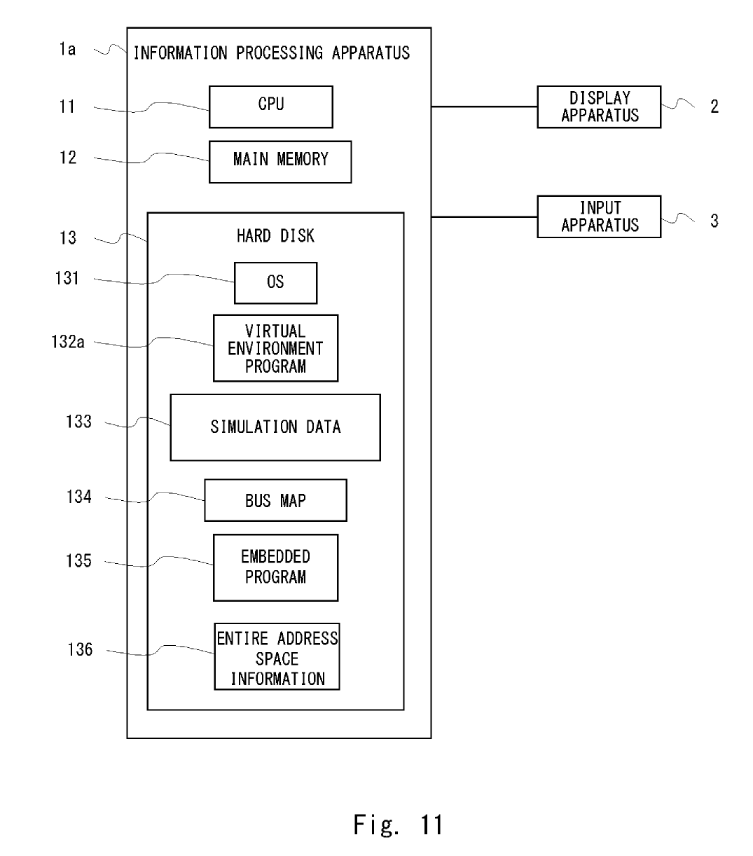

FIG. 11 is a block diagram for describing an overall configuration of an information processing apparatus la according to the second embodiment. As compared to the above-described information processing apparatus 1, in the information processing apparatus la, the virtual environment program 132 of the information processing apparatus 1 is replaced by a virtual environment program 132a, and entire address space information 136 is added. When the virtual environment program 132a is executed by the CPU 11, the virtual environment program 132a further functions as the above-described area reserving unit and access processing unit in addition to functioning as the virtual environment program 132.

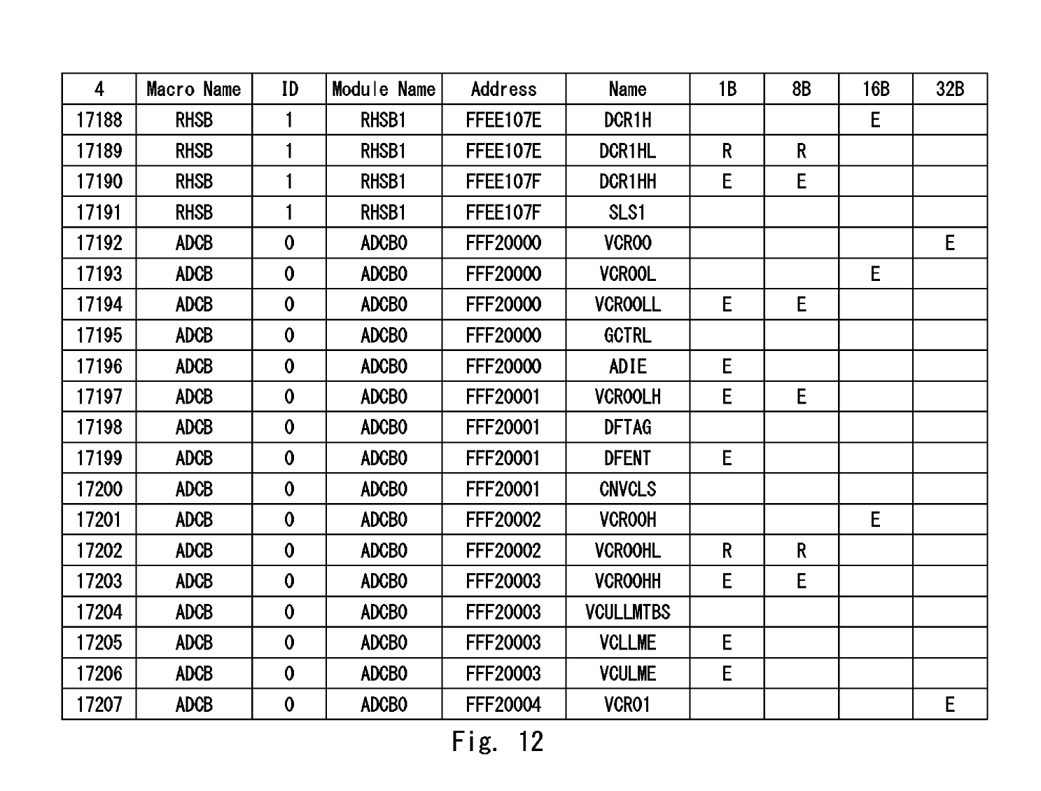

The entire address space information 136 is information defining address information of all access destinations (all circuits) in the embedded device corresponding to the embedded program 135. Here, FIG. 12 is a diagram showing an example of the entire address space information 136 according to the second embodiment.

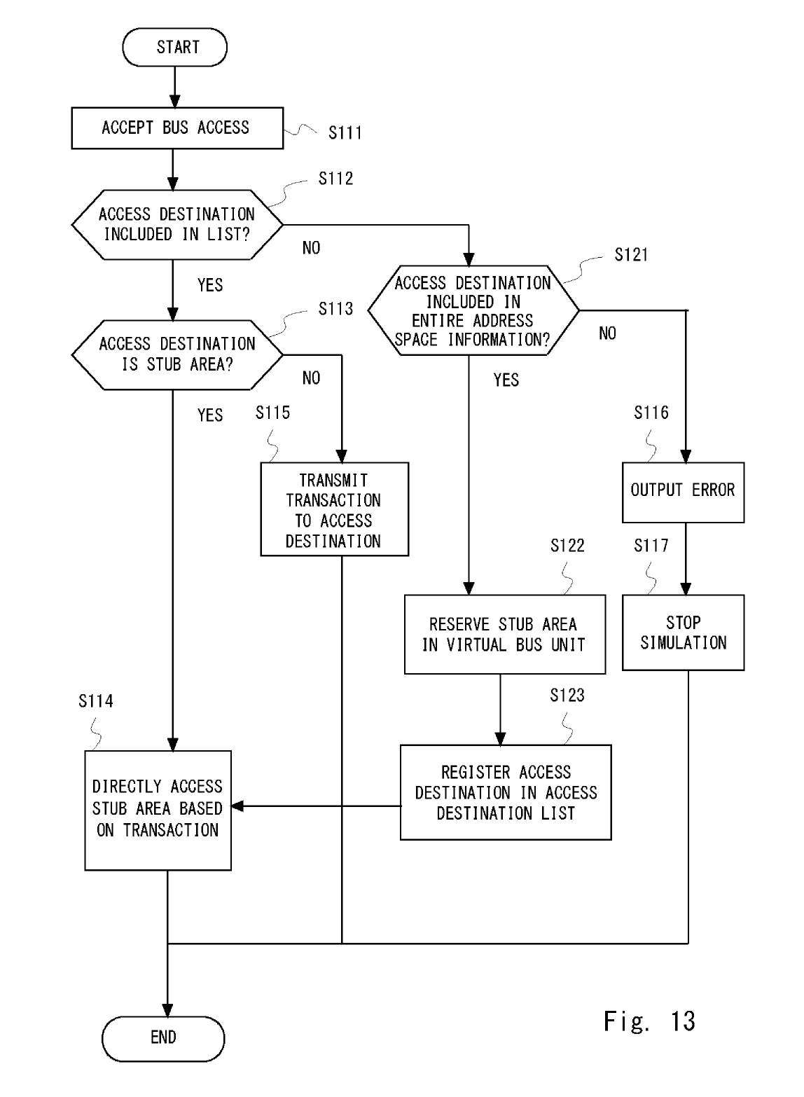

FIG. 13 is a flowchart for describing a flow of the bus access processing according to the second embodiment. Note that the same processing as that in FIG. 6 described above will be omitted as appropriate.

In Step S112, when the access destination is not included in the access destination list 421, the area reserving unit 423 evaluates as to whether or not the access destination is included in the entire address space information 136 (S121). For example, the area reserving unit 423 searches the start address of the bus access transaction from the entire address space information 136. When the search results in a hit, i.e., when the access destination is included in the entire address space information 136, the area reserving unit 423 reserves, as the stub area 422, the storage area corresponding to the access destination in the virtual bus unit 42 (S122). The method of reserving the stub area is the same as that in the above-described Step S107.

Then, the area reserving unit 423 registers the access destination in the access destination list 421 (S123). Thus, as the access destination is included in the list in the subsequent bus access, it becomes unnecessary to reserve the stub area again. Therefore, the efficiency of the processing can be improved. Note that the method of registration in the access destination list is the same as that in the above-described Step S108.

After that, the access processing unit 424 directly accesses the stub area reserved in Step S122 based on the transaction (S114). The process of Step S114 is described above.

In Step S121, when the access destination is not included in the entire address space information 136, the access processing unit 424 outputs an error message to the display apparatus 2 (S116). Then, the access processing unit 424 stops the simulation (S117). In this case, as the address information of the access destination of the bus access is an address not allowed by the hardware, it is unnecessary for the user to determine the cause of the error.

As described above, according to the second embodiment, the debugging work can be made more efficient and the load on the user can be reduced.

### Other Embodiments

Each of the above-described embodiments can correspond to, for example, b_transport, nb_transport_fw, transport dbg in IEEE (Institute of Electrical and Electronics Engineers)-1666-2011.

Although the invention made by the present inventor has been described in detail based on the embodiments, it is obvious that the present disclosure is not limited to the above embodiments, and various modifications can be made without departing from the scope of the invention.

The first and second embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. An information processing apparatus comprising a virtual environment for executing an embedded program for a predetermined embedded device, wherein
the virtual environment comprises a virtual bus unit including an access processing unit that processes bus access in the execution of the embedded program, and
the virtual bus unit comprises an area reserving unit that reserves, when an access destination of the bus access is not defined in the virtual environment, a storage area corresponding to the access destination as a stub area in the virtual bus unit.

2. The information processing apparatus according to claim 1, wherein
when the access destination is a slave connected to the virtual bus unit, the access processing unit transmits an access instruction regarding the bus access to the access destination, and
when the access destination is the stub area, the access processing unit directly accesses the stub area in accordance with the access instruction.

3. The information processing apparatus according to claim 1, further comprising a storage unit configured to store a bus map, the bus map defining address information of a plurality of circuit blocks defined in the virtual environment as the access destinations, wherein
the bus map further defines the address information of the access destination not defined in the virtual environment as stub information, and
the area reserving unit refers to the bus map and reserves the storage area corresponding to the stub information as the stub area in the virtual bus unit.

4. The information processing apparatus according to claim 3, wherein
the area reserving unit
reads the bus map when the execution of the embedded program is started,
registers, among the access destinations defined in the bus map, the address information of the slave connected to the virtual bus unit of the information processing apparatus in an access destination list in the virtual bus unit, and
when the stub information is defined in the bus map, further registers the stub information in the access destination list, and
when the access processing unit accepts the bus access, it refers to the access destination list and evaluates as to whether or not the access destination is the stub area.

5. The information processing apparatus according to claim 3, wherein when the access processing unit accepts the bus access and the access destination is not defined in the bus map, the access processing unit outputs the bus access as an error.

6. The information processing apparatus according to claim 1, further comprising a storage unit configured to store entire address space information, the entire address space information defining the address information of all of the access destinations in the execution of the embedded program,
wherein when there is, in the entire address space information, the access destination not defined in the virtual environment among the access destinations of the bus access, the area reserving unit reserves the storage area corresponding to the access destination as the stub area in the virtual bus unit.

7. The information processing apparatus according to claim 6, wherein
the area reserving unit registers the stub information indicating the reserved stub area in the access destination list, and
when the access processing unit accepts the bus access, it refers to the access destination list and when the access destination is the stub area, the access processing unit directly accesses the stub area in accordance with the access instruction regarding the bus access.

8. The information processing apparatus according to claim 6, wherein when it is evaluated that the access destination is not included in the entire address space information, the access processing unit outputs the bus access as unauthorized access.

9. A control method of an information processing apparatus including a virtual environment for executing an embedded program for a predetermined embedded device, the control method comprising:
reserving, when an access destination of bus access in the execution of the embedded program is not defined in the virtual environment, a storage area corresponding to the access destination as a stub area in a virtual bus unit included in the virtual environment; and
processing the bus access.

10. A non-transitory computer readable medium storing a control program of an information processing apparatus including a virtual environment for executing an embedded program for a predetermined embedded device, the control program causing the information processing apparatus to execute:
reserving, when an access destination of bus access in the execution of the embedded program is not defined in the virtual environment, a storage area corresponding to the access destination as a stub area in a virtual bus unit included in the virtual environment; and
processing the bus access.
